(19) United States
(12) Patent Application Publication
(10) Pub. No.: US 2007/0020966 A1
(43) Pub. Date: Jan. 25, 2007

(54) Board shaped electrical connector

(75) Inventors: Dick Lee, Taipei (TW); Ta-Teh Meng, Taipei (TW); Chien-Li Kuan, Taipei (TW); Tung Hwa Hu, Taipei (TW)

Correspondence Address: BRUCE H. TROXELL, SUITE 1404, 5205 LEESBURG PIKE, FALLS CHURCH, VA, 22041, US

(73) Assignee: Advanced Connectek Inc.

(21) Appl. No.: 11/411,792

(22) Filed: Apr. 27, 2006

(30) Foreign Application Priority Data
Jul. 22, 2005 (TW) 094212423

(51) Int. Cl. H01R 12/00

(52) U.S. Cl. 439/74

(57) ABSTRACT

A board shaped electrical connector includes a rectangular female section 1 comprising a raised portion 11 in a lengthwise groove 111, widthwise channels 12 at either half, two side fastening blocks 13, and conductors 2 in the channels 12 and each including a U-shaped contact 21 having hooked ends 212, and a fastening member 22 including a projection 221 in the fastening block 13, and a first space 226 formed between the conductor 2 and the channel 12; and a rectangular male section 3 comprising top slopes 312, a lengthwise cavity 33, widthwise channels 34 at either half and being in communication with the slopes 312, and conductors 35 in the channels 34 and each including a U-shaped slip-resistant portion 353 at the other end. In an assembled state the male section 3 is inserted in the female section 1 with the conductor 35 fastened by the hooked ends 212.

### BACKGROUND OF THE INVENTION

1. Field of Invention

The present invention relates to electrical connectors and more particularly to such an electrical connector comprised of a male section and a female section secured to the male section such that reliable elastic electrical interconnections of conductors are made possible.

2. Description of Related Art

A conventional board shaped electrical connector comprises a male section mounted on one PCB (printed circuit board) and a female section mounted on the other PCB. Once they are assembled, an electrical connection is formed and a signal communication is thus made possible therebetween. Conventionally, either the male section or the female section has an insulative body including a plurality of channels and a plurality of conductors inserted through the channels. An electrical connector is formed by snappingly assembling the male section and the female section together.

However, the prior electrical connector suffered from several disadvantages. For example, spacing between two adjacent channels is relatively large. This contradicts the trend of compactness in the development of electrical connectors. Further, the elastic contact between conductors of the male section and the female section is not reliable. Thus, its fastening may be compromised if a strong force is exerted thereon. Furthermore, conductors may be damaged due to insufficient structural strength. Moreover, the assembly process involving snapping is complicated. Hence, its yield is low, resulting in an increase in the manufacturing cost. Thus, the need for improvement still exists in order to overcome the inadequacies of the prior art.

### SUMMARY OF THE INVENTION

It is therefore an object of the present invention to provide a board shaped electrical connector comprised of a male section and a female section having its conductors lockingly engaged with that of the male section such that reliable elastic electrical connections between the conductors are effected.

It is another object of the present invention to provide a board shaped electrical connector in which the female section thereof having its conductors formed integrally by injection molding such that it is possible of decreasing the possibility of damaging the conductors to a minimum and decreasing a spacing between any two adjacent conductors to a minimum.

It is a further object of the present invention to provide a board shaped electrical connector in which the male section thereof has a securing and vibration proof mechanism provided in its conductors such that the assembly of the male section and the female section is more secure.

To achieve the above and other objects, the present invention provides a board shaped electrical connector comprising a rectangular female section comprising a lengthwise groove, a rectangular raised portion in the groove, a plurality of widthwise parallel channels at either half portion of the female section, two fastening blocks each disposed in either side of the female section, and a plurality of conductors disposed in the channels and each including a U-shaped contact including two opposite, flexible arms each having a hooked end, and a fastening member including a projection disposed within the fastening block and including two opposite engaging portions on a bottom of the fastening block, and a plurality of protrusions projected into the fastening block, a solder portion extended from a root of the projection, an electrical terminal at an outer end, and a first space formed between a bottom of the conductor and a bottom of the channel; and a rectangular male section comprising an insulative body including a plurality of top slopes, a lengthwise cavity, a plurality of widthwise parallel channels at either half portion of the male section and being in communication with the slopes, and a plurality of conductors disposed in the channels and each including a body, a solder terminal at one end of the body, and a U-shaped slip-resistant portion at the other end of the body; wherein in an assembled state of the electrical connector the male section is inserted in the female section with the conductors of the male section disposed in the groove, and the body of each conductor of the male section fastened by the hooked ends.

The above and other objects, features and advantages of the present invention will become apparent from the following detailed description taken with the accompanying drawings.

### BRIEF DESCRIPTION OF THE DRAWINGS

FIG. 1 is a perspective view of a female section of a first preferred embodiment of electrical connector according to the invention;

FIG. 2 is a perspective view of a male section of the electrical connector;

FIG. 3 is a perspective view of the male section and the female section to be assembled together; and

FIG. 4 is a sectional view of the assembled electrical connector.

### DETAILED DESCRIPTION OF THE INVENTION

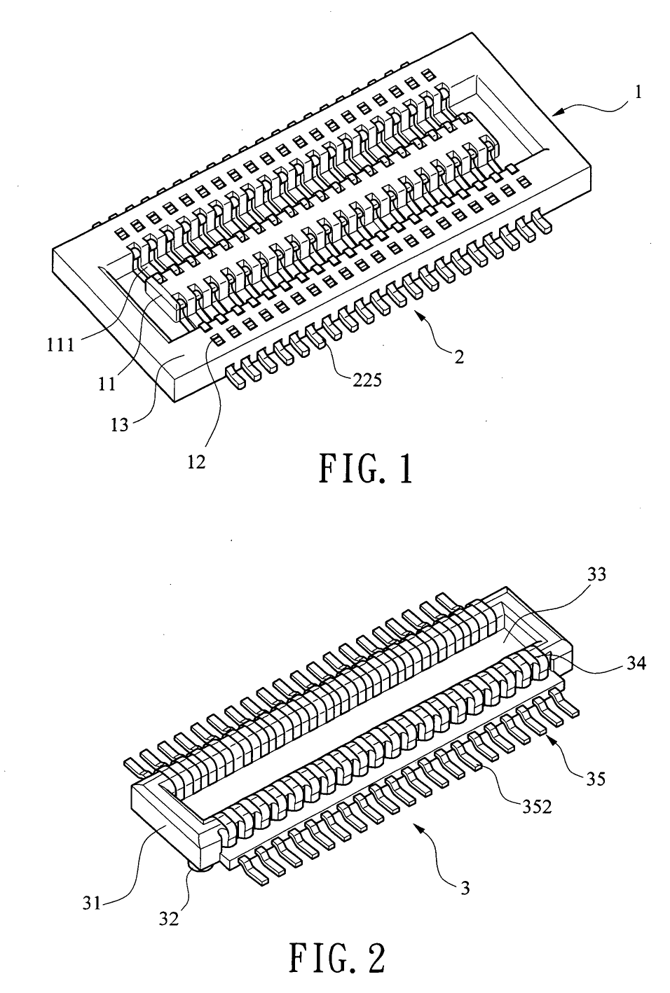

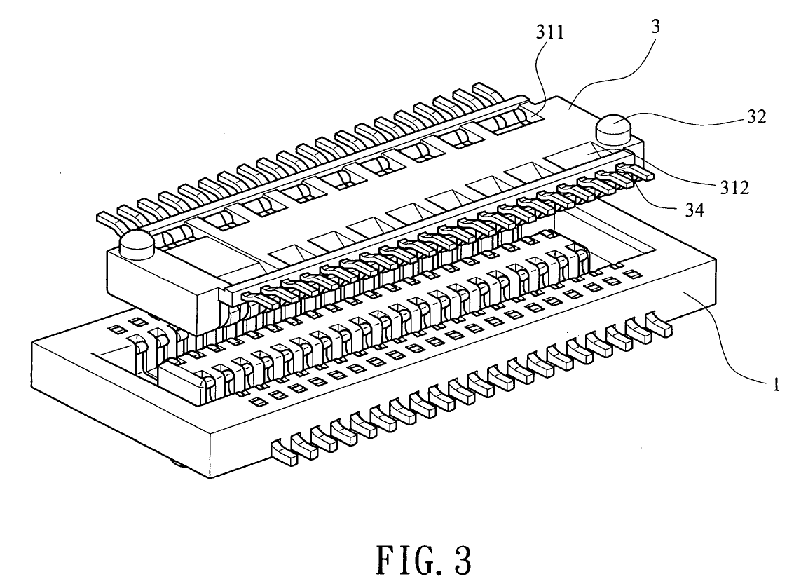

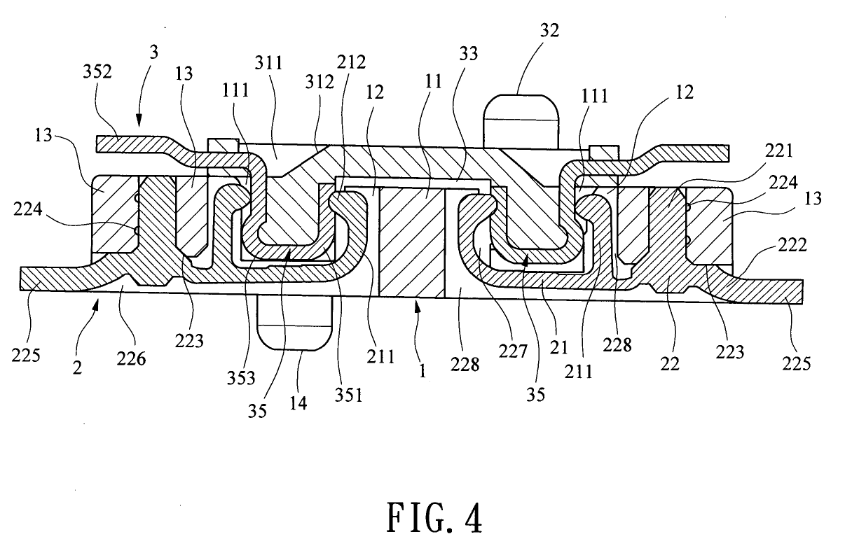

Referring to FIGS. 1 to 4, a board shaped electrical connector in accordance with a preferred embodiment of the invention comprises a male section 3 and a female section 1. Each component is discussed in detailed below.

The female section 1 has a rectangular shape and comprises a lengthwise rectangular groove 111, a rectangular raised portion 11 in the groove 111, a plurality of positioning pegs 14 on an underside, the positioning peg 14 having an inclined end surface, a plurality of widthwise parallel channels 12 at either half portion of the female section 1, a plurality of conductors 2 each disposed in the channel 12 as detailed later, and two fastening blocks 13 each disposed in either side of the female section 1 as detailed later.

The conductor 2 comprises a U-shaped contact 21 including two flexible arms 211 facing each other and each having a hooked end 212 also facing each other, and a fastening member 22 including a postlike projection 221 disposed within the fastening block 13 and including two opposite engaging portions 223 on a bottom of the fastening block 13, and a plurality of protrusions 224 received in corresponding recesses of the fastening block 13, a solder portion 222 extended from a root of the projection 221, and an electrical terminal 225 at an outer end. A first space 226 is formed between a bottom of the conductor 2 and a bottom of the channel 12. Two third spaces 228 wherein one third space 228 is formed between the intermediate arm 211 and the fastening block 13 and the other third space 228 is formed between the end arm 211 and the raised portion 11.

The male section 3 has a rectangular shape and comprises an insulative body 31 including a plurality of slopes 312 on a top, a plurality of positioning pegs 32 on the top, the positioning peg 32 having an inclined end surface, a lengthwise rectangular cavity 33 opposite the positioning pegs 32, a plurality of widthwise parallel channels 34 at either half portion of the male section 3 and being in communication with the slopes 312, and a plurality of conductors 35 each disposed in the channel 34.

The conductor 35 comprises a body 351, a solder terminal 352 at one end of the body 351, and a U-shaped slip-resistant portion 353 at the other end of the body 351.

An assembly operation of the invention will be described in detailed below. First, dispose the conductors 2 in the channels 12 until the engaging portions 223 are engaged with the bottoms of the fastening block 13 and the projections 221 are also disposed within the fastening block 13. The protrusions 224 are engaged with the recesses of the fastening block 13. Two third spaces 228 are thus formed and are adapted to provide a buffering space when an external force is exerted upon the conductors. Hence, a possibility of breaking the conductors is decreased to a minimum. The conductors 2 are thus secured in the female section 1 by injection molding. This has the benefits of saving the manufacturing time and cost. Next, dispose the conductors 35 in the channels 34 and the slopes 312 which is served as a securing and vibration proof mechanism so as to prevent the conductors 35 from dislodging. Thus, the conductors 35 are secured in the male section 3 by injection molding. In a final step, insert the male section 3 in the female section 1 with the conductors 35 disposed in the groove 111. A second space 227 as buffer is formed between the arms 211 with the body 351 of each conductor 35 sandwiched between and fastened by the hooked ends 212. As an end, the female section 1 and the male section 3 are lockingly secured together.

While the invention herein disclosed has been described by means of specific embodiments, numerous modifications and variations could be made thereto by those skilled in the art without departing from the scope and spirit of the invention set forth in the claims.

What is claimed is:

1. An electrical connector comprising:
a rectangular female section (1) comprising a lengthwise groove (111), a rectangular raised portion (11) in the groove (111), a plurality of widthwise parallel channels (12) at either half portion of the female section (1), two fastening blocks (13) each disposed in either side of the female section (1), and a plurality of conductors (2) disposed in the channels (12) and each including a U-shaped contact (21) including two opposite, flexible arms (211) each having a hooked end (212), and a fastening member (22) including a projection (221) disposed within the fastening block (13) and including two opposite engaging portions (223) on a bottom of the fastening block (13), and a plurality of protrusions (224) projected into the fastening block (13), a solder portion( 222) extended from a root of the projection (221), an electrical terminal (225) at an outer end thereof, and a first space (226) formed between a bottom of the conductor (2) and a bottom of the channel (12); and
a rectangular male section (3) comprising an insulative body (31) including a plurality of top slopes (312), a lengthwise cavity (33), a plurality of widthwise parallel channels (34) at either half portion of the male section (3) and being in communication with the slopes (312), and a plurality of conductors (35) disposed in the channels (34) and each including a body (351), a solder terminal (352) at one end of the body (351), and a U-shaped slip-resistant portion (353) at the other end of the body (351);
wherein in an assembled state of the electrical connector the male section (3) is inserted in the female section (1) with the conductors (35) disposed in the groove (111), and the body (351) of each conductor (35) fastened by the hooked ends (212).

2. The electrical connector of claim 1, further comprising a second space (227) formed between the arms (211).

3. The electrical connector of claim 1, further comprising two third spaces (228) wherein one third space (228) is formed between the intermediate arm (211) and the fastening block (13) and the other third space (228) is formed between the end arm (211) and the raised portion (11).

4. The electrical connector of claim 1, wherein the female section (1) further comprises a plurality of positioning pegs (14) on an underside, the positioning peg (14) having an inclined end surface.

5. The electrical connector of claim 1, wherein the male section (3) further comprises a plurality of positioning pegs (32) on a top, the positioning peg (32) having an inclined end surface.
